(19) United States
(12) Patent Application Publication
(10) Pub. No.: US 2011/0044127 A1
(43) Pub. Date: Feb. 24, 2011

(54) REMOVING FREE-SURFACE EFFECTS FROM SEISMIC DATA ACQUIRED IN A TOWED SURVEY

(76) Inventors: Clement Kostov, Trumpington (GB); Martin Musil, Brno (CZ); Johan Robertsson, Grantchester (GB); Ed Kragh, Essex (GB)

Correspondence Address: WesternGeco L.L.C.;Kevin McEnaney, IP Dept, 10001 Richmond Avenue, HOUSTON, TX, 77042-4299, US

(21) Appl. No.: 12/543,627

(22) Filed: Aug. 19, 2009

(51) Int. Cl. G01V 1/38; G01V 1/28

(52) U.S. Cl. 367/16; 367/15; 367/24

(57) ABSTRACT

A technique includes towing a spread of at least one streamer to acquire seismic data in response to energy produced by a seismic source. The technique includes towing the seismic source at least 100 meters behind a front end of the spread to configure the spread to acquire a split spread gather record.

### BACKGROUND

The invention generally relates to removing free-surface effects from seismic data acquired in a towed survey.

Seismic exploration involves surveying subterranean geological formations for hydrocarbon deposits. A survey typically involves deploying seismic source(s) and seismic sensors at predetermined locations. The sources generate seismic waves, which propagate into the geological formations creating pressure changes and vibrations along their way. Changes in elastic properties of the geological formation scatter the seismic waves, changing their direction of propagation and other properties. Part of the energy emitted by the sources reaches the seismic sensors. Some seismic sensors are sensitive to pressure changes (hydrophones), others to particle motion (e.g., geophones and/or accelerometers), and industrial surveys may deploy only one type of sensors or both. In response to the detected seismic events, the sensors generate electrical signals to produce seismic data. Analysis of the seismic data can then indicate the presence or absence of probable locations of hydrocarbon deposits.

Some surveys are known as “marine” surveys because they are conducted in marine environments. However, “marine” surveys may be conducted not only in saltwater environments, but also in fresh and brackish waters. In one type of marine survey, called a “towed-array” survey, an array of seismic sensor-containing streamers and sources is towed behind a survey vessel.

### SUMMARY

In an embodiment of the invention, a technique includes towing a spread of at least one streamer to acquire seismic data in response to energy produced by a seismic source. The technique includes towing the seismic source at least 100 meters behind a front end of the spread to configure the spread to acquire a split spread gather record.

In another embodiment of the invention, a technique includes receiving a split spread seismic record acquired by seismic sensors while in tow and processing the split spread gather record to remove free surface effects indicated by the record.

In another embodiment of the invention, a system includes a seismic source, a spread of at least one streamer and a vessel. The spread acquires seismic data in response to energy produced by a seismic source, and the vessel tows the seismic source at least 100 meters behind a front end of the spread to configure the spread to acquire a split spread gather record.

In yet another embodiment of the invention, a system includes an interface and a processor. The interface receives a split spread seismic record acquired by seismic sensors while in tow, and the processor processes the split spread gather record to remove free surface effects indicated by the record.

Advantages and other features of the invention will become apparent from the following drawing, description and claims.

### BRIEF DESCRIPTION OF THE DRAWING

FIGS. 1 and 5 are schematic diagrams of marine-based seismic data acquisition systems according to embodiments of the invention.

FIG. 2 is a flow diagram depicting a technique to acquire a split spread gather record according to an embodiment of the invention.

FIG. 3 is a flow diagram depicting a technique to process seismic data to remove free surface effects according to an embodiment of the invention.

FIG. 4 is a schematic diagram of a processing system according to an embodiment of the invention.

### DETAILED DESCRIPTION

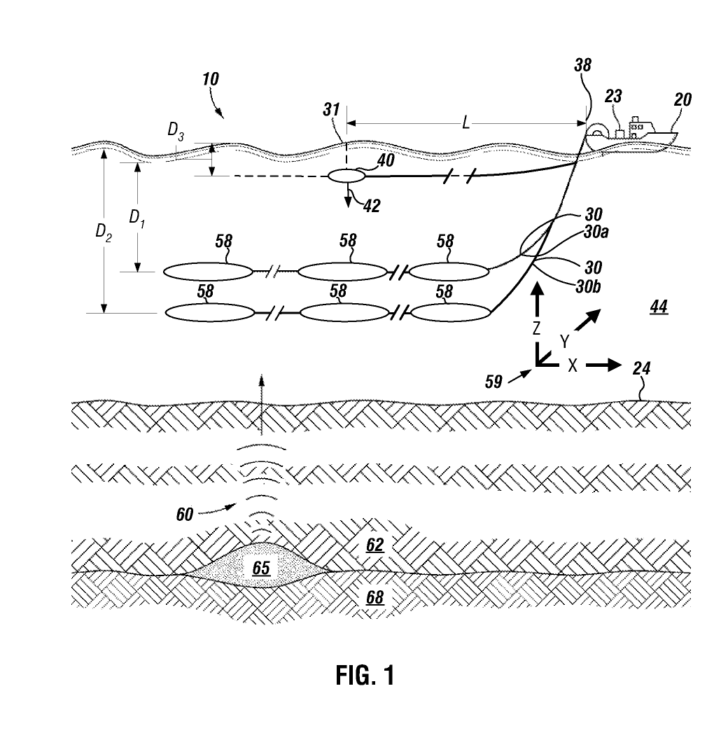

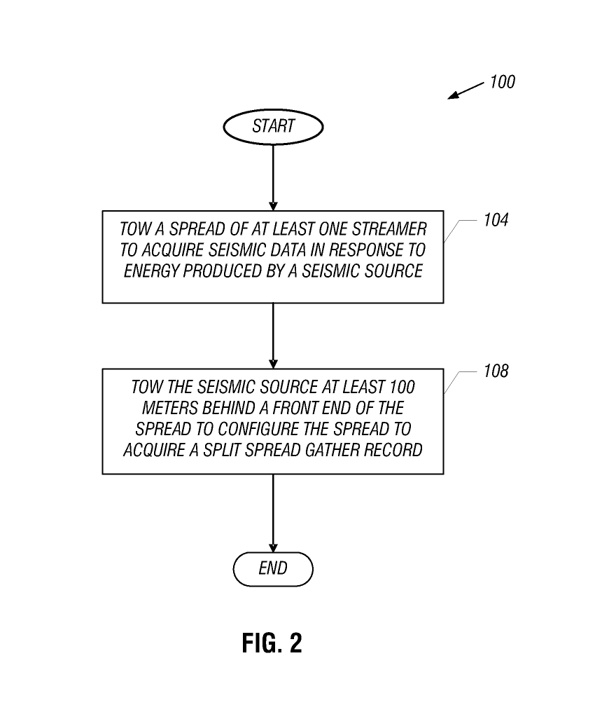

FIG. 1 depicts an embodiment 10 of a marine seismic data acquisition system in accordance with some embodiments of the invention. In the system 10, a survey vessel 20 tows a spread of seismic streamers 30. For the arrangement depicted in FIG. 1, the seismic spread is an over/under spread. In this manner, the spread includes a first set of one or more streamers 30a (one streamer 30a being depicted in FIG. 1) that are towed at a relatively shallow depth (called “D₁” in FIG. 1) and a second set of one or more streamers 30b (one streamer 30b being depicted in FIG. 1) that are towed at a relatively deeper depth (called “D₂” in FIG. 2) beneath the streamer(s) 30a.

Each of the seismic streamers 30 may be several thousand meters long and may contain various support cables (not shown), as well as wiring and/or circuitry (not shown) that may be used to support communication along the streamer 30. In general, each streamer 30 includes a primary cable into which are mounted seismic sensors 58 that record seismic signals.

In accordance with embodiments of the invention, the seismic sensors 58 may be pressure sensors only or may be multi-component seismic sensors, which sense pressure and particle motion. For the case of multi-component seismic sensors, each sensor is capable of detecting a pressure wavefield and at least one component of a particle motion that is associated with acoustic signals that are proximate to the multi-component seismic sensor. Examples of particle motions include one or more components of a particle displacement, one or more components (inline (x), crossline (y) and vertical (z) components (see axes 59, for example)) of a particle velocity and one or more components of particle acceleration.

Depending on the particular embodiment of the invention, the multi-component seismic sensor may include one or more hydrophones, geophones, particle displacement sensors, particle velocity sensors, accelerometers, pressure gradient sensors, or combinations thereof. For example, in accordance with some embodiments of the invention, a particular multi-component seismic sensor may include a hydrophone for measuring pressure and three orthogonally-aligned accelerometers to measure three corresponding orthogonal components of particle velocity and/or acceleration near the seismic sensor. It is noted that the multi-component seismic sensor may be implemented as a single device or may be implemented as a plurality of devices, depending on the particular embodiment of the invention. A particular multi-component seismic sensor may also include pressure gradient sensors, which constitute another type of particle motion sensors. Each pressure gradient sensor measures the change in the pressure wavefield at a particular point with respect to a particular direction. For example, one of the pressure gradient sensors may acquire seismic data indicative of, at a particular point, the partial derivative of the pressure wavefield with respect to the crossline direction; another one of the pressure gradient sensors may acquire, at a particular point, seismic data indicative of the partial derivative of the pressure data with respect to the inline direction; and another one of pressure gradient sensors may acquire, at a particular point, seismic data indicative of the partial derivative of the pressure data with respect to the vertical direction.

Among its other features, the marine seismic data acquisition system 10 includes a seismic source 40 that may be formed from one or more seismic source elements, such as air guns, for example, which are connected to the survey vessel 20. Alternatively, in other embodiments of the invention, the seismic source 40 may operate independently of the survey vessel 20, in that the seismic source 40 may be coupled to other vessels or buoys, as just a few examples.

As the seismic streamers 30 are towed behind the survey vessel 20, acoustic signals 42 (an exemplary acoustic signal 42 being depicted in FIG. 1), often referred to as “shots,” are produced by the seismic source 40 and are directed down through a water column 44 into strata 62 and 68 beneath a water bottom surface 24. The acoustic signals 42 are reflected from the various subterranean geological formations, such as an exemplary formation 65 that is depicted in FIG. 1.

The incident acoustic signals 42 that are created by the seismic source 40 produce corresponding reflected acoustic signals, or pressure waves 60, which are sensed by the seismic sensors of the seismic sensor unit 58. It is noted that the pressure waves that are received and sensed by the seismic sensors 58 include “up going” pressure waves that propagate to the sensors 58 without reflection, as well as “down going” pressure waves that are produced by reflections of the pressure waves 60 from an air-water boundary, or free surface 31.

In accordance with embodiments of the invention, the seismic data acquired by the seismic sensors 58 is processed to remove multiple reflections, which are produced by the free surface 31. In this regard, the seismic data may be processed by free surface multiple removal techniques, such as the techniques described in Amundsen, L., 2001, Elimination of Free-Surface Related Multiples Without Need of The Source Wavelet: Geophysics, Soc. of Expl. Geophys., 66, 327-341; and Dragoset, W. H. and Jeri\check{c}ević, Z., 1998, Some Remarks On Surface Multiple Attenuation: Geophysics, Soc. of Expl. Geophys., 63, 772-789. These techniques assume a split spread gather in which the seismic sensors, or receivers, are located (from an inline standpoint) on both sides of the seismic source, such as is the case for a seabed acquisition. For a marine-based towed survey, however, the seismic records that are acquired in the survey have conventionally been off-end shot gathers, due to all receivers being traditionally located on one side of the seismic source because the receivers are traditionally towed behind the seismic source. Also, in the conventional processing of streamer data, the seismic events known as direct wave (i.e., energy propagating from source to receiver in the water, without interaction with the free-surface or sea bed) and its ghost are suppressed, as compared to here in which the interest is in recording and processing these events.

One potential way to process the seismic record acquired in a conventional towed survey is to artificially create a split spread gather through the principle of reciprocity. In this processing technique, reciprocal traces for which the source and receiver positions are interchanged on the basis of a source/receiver reciprocity argument. It is noted, however, that the reciprocity argument is valid provided the same (e.g. isotropic) directivities for sources and receivers are assumed and other acquisition conditions are unchanged. The first premise, and in particular ignoring source directivity is not a very good approximation, especially at high frequencies and take-off angles away from the vertical. This second premise does not hold true for rough sea conditions in that significant variations in the sea surface shape occur with respect to time and space. The perturbations caused by the rough sea surface may lead to interpretation errors if the rough sea effects are not properly taken into account. Furthermore, properly accounting for rough sea surface effects on primaries and multiples may be particularly important for time lapse survey analysis. Finally, the reciprocity principle does not allow the filling in of traces near the source array in the so-called near-offset gap, where trace interpolation is needed. Embodiments of the invention described herein do not require these assumptions in order to obtain split-spread gathers, with traces near the source array, and the complete wavefield.

In accordance with embodiments of the invention, which are described herein, techniques and systems are disclosed for purposes of directly acquiring a split spread gather record in a marine-based towed survey. In this manner, referring to FIG. 1, in accordance with embodiments of the invention, the seismic source 40 is not towed at the leading, or front, end 38 of the spread of streamers 30; but rather, the seismic source 40 is towed a significant distance (called “L” in FIG. 1) behind the front end 38. When the seismic source position is considered to be a “zero offset,” the above-described positioning of the seismic source 40 creates sensor, or receiver, positions at negative offsets between the source 40 and the vessel 20 and receiver positions at positive offsets behind both the source 40 and the vessel 20.

In accordance with embodiments of the invention, the split spread gather records the incident wavefield for relevant take-off directions of the source signal. This may be achieved by towing the streamers 30 at a relatively large depth, such as a depth that may be 50 meters or more, in accordance with some embodiments of the invention. It is noted that although the majority of the streamer spread may be at the 50 meter depth, the sensors at the lead-in may be as shallow as ten to twenty meters. In this regard, the depth of the streamers may gradually increase as a function of the inline offset of the streamers so that the majority of the streamer spread is at the 50 meter depth. The streamers may be towed at other depths in accordance with other embodiments of the invention. As a non-limiting example, the streamers may be towed between 50 to 100 meters, in accordance with some embodiments of the invention.

It is noted that towing the streamers 30 at these depths and at possibly even greater depths may be advantageous in processing applications that exploit the differences in sub-surface illumination between the upgoing and downgoing wavefields.

In the context of this application, a “split spread gather” means a gather in which receivers are located at negative and positive offsets with respect to the source. It is noted that a split spread gather record may still be acquired even if the seismic source 40 is not positioned exactly at the inline midpoint of the streamer spread, in that the number of negative and positive offsets do not necessarily have to be equal. Thus, many variations are contemplated and are within the scope of the appended claims.

In accordance with some embodiments of the invention, the distance L at which the seismic source 40 is towed behind the front end 38 may be a distance between 100 to 200 meters (m), and more specifically, the distance L may be as large as one to two kilometers (km), in accordance with some embodiments of the invention. Additionally, in accordance with some embodiments of the invention, measurements acquired at negative offsets that are relatively close to the seismic source 40 may be excluded from the multiple removal processing. As a more specific example, in accordance with some embodiments of the invention, measurements that are acquired at negative offsets less than one kilometer away from the seismic source 40 may be excluded. The negative offsets may be excluded based on another policy, in accordance with other embodiments of the invention.

To summarize, FIG. 2 depicts a technique 100 that may be used in accordance with some embodiments of the invention for purposes of acquiring seismic data in a form, which may be processed to remove free surface multiples in the presence of a rough sea. Pursuant to the technique 100, a spread of at least one streamer is towed (block 104) to acquire seismic data in response to energy produced by a seismic source. The seismic source is towed at least 500 meters behind a front end of the spread, pursuant to block 108, to configure the spread to acquire a split spread gather record.

The technique 100 is the first of two prerequisites that are satisfied to facilitate free surface multiple removal. The second prerequisite relates to the configuration of the streamer spread itself. More specifically, the streamer spread is configured to facilitate the separation of the upgoing and downgoing wavefields at the receiver array. By way of example, FIG. 1 depicts an over/under spread, which may be particularly used in embodiments of the invention in which the streamers only contain pressure sensors. In this regard, the different vertical spacing of the seismic streamers (and thus, the different vertical spacings of the pressure sensors) allows differentiation of the sensed upgoing pressure waves from the downgoing pressure waves.

In accordance with some embodiments of the invention, a Trisor®/Calibrated Marine Source (CMS) technique may be used to estimate the component of the downgoing wavefield, which includes the direct and its ghost. The technique uses measurements from hydrophones located close to each gun of the seismic source array such that the measurements are processed using a notational source algorithm. As a result of this processing, estimates of the direct wave and its ghost at a new location in the water layer may be determined, and the technique is sufficiently accurate for seismic applications when the receivers are located from beyond a few tens of meters (e.g., 20-30 m) from the center of the source array to a few kilometers away from the source array.

In another variation, the streamer spread that is depicted in FIG. 1 may be replaced by one or more multi-component streamers, where each streamer contains multi-component sensors that sense both pressure and particle motion. The additional information provided by the sensed particle motion permits the separation of the upgoing and downgoing wavefields, as can be appreciated by one of skill in the art. Furthermore, the over/under configuration is not necessarily for upgoing/downgoing wavefield separation when multi-component sensors are employed. Thus, many variations are contemplated and are within the scope of the appended claims.

For such benefits as reducing bad weather down time during acquisition, the seismic source 40 (FIG. 1) may be towed at a deeper depth (called “D₃” in FIG. 1) than the depth at which the source is towed in conventional surveys. In this regard, traditionally, the seismic source may be towed at a relatively shallow depth for purposes of minimizing ghost perturbations in the detected waves, which are attributable to the seismic source. However, because a split spread gather record is acquired, the free surface multiple removal technique may be applied to significantly attenuates any source side ghost that may be caused by deeper towing. As a result, the seismic source 40 may be towed at the deeper depth D₃ to avoid the effects of bad weather without incurring the traditional problems that typically arise when such a deeper depth is used.

A minimum distance is maintained between the seismic source 40 and the streamers 30 so that all seismic events, including the relatively strong amplitude direct arrivals, are accurately recorded.

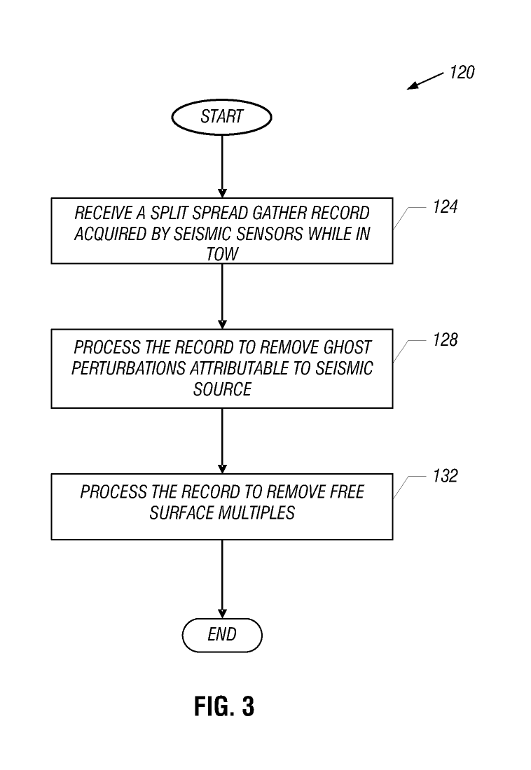

Upon acquiring the split spread gather record using a seismic acquisition system, such as the system 10 that is depicted in FIG. 1, the record may be processed using a free surface multiple removal technique. This technique both accounts for rough sea conditions, as well as significantly attenuates the ghost perturbations that are introduced by the source 40. Therefore, referring to FIG. 3 in conjunction with FIG. 1, in accordance with some embodiments of the invention, a technique 120 includes receiving a split spread gather record acquired by seismic sensors while in tow, pursuant to block 124, and subsequently processing the split spread gather record to remove free surface effects. More specifically, the technique 120 includes processing (block 128) the split spread gather record to remove ghost perturbations that are attributable to the seismic source and processing (block 132) the split spread gather record to remove free surface multiples. Any free surface multiple removal technique based on a split spread gather may be used, such as, as examples, the techniques described in the Amundsen, L., 2001; and Dragoset, W. H. and Jeri\check{c}ević, Z., 1998 references mentioned above, as a few non-limiting examples. In some instances, even with the new acquisition setup, some parts of the split spread gather may be missing. In such case, an additional step of data conditioning, using a combination of the conventional approaches based on reciprocity and near-offset interpolation for the scattered part of the wavefield may be used; and a different approach for the estimation of the direct arrival and its ghost may be used, such as the technique based on a near-field hydrophone measurements, as disclosed in GB patent application (Attorney Docket No. 57.0815).

It is noted that free surface multiple removal is one of many different applications that may process the split spread gather record. As examples, in accordance with the many possible embodiments of the invention, techniques such as Depth Imaging using Primary and Multiple Reflections (DIPMR), Full Waveform Inversion (FWI) and Surface Related Multiple Elimination (SRME) may process the split spread gather record. Thus, many variations are contemplated and are within the scope of the appended claims.

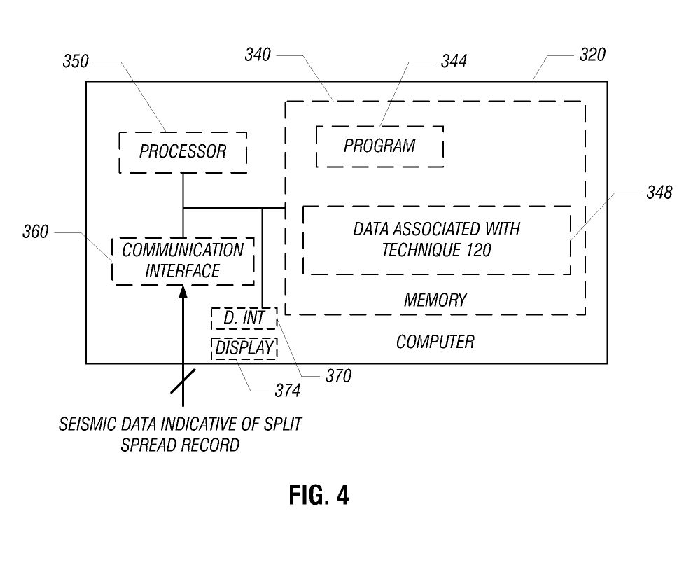

Referring to FIG. 4, in accordance with some embodiments of the invention, a data processing system 320 may perform at least part of the techniques that are disclosed herein, for purposes of processing seismic data, which are indicative of a split spread gather record that was directly acquired in a marine-based towed survey. Thus, the system 320 may be used for such purposes of removing free surface effects, even if the effects were acquired in the presence of a rough sea; removing source side ghost; depth imaging; full waveform inversion; etc.

The system 320 may be located on one of the streamers 30, on each streamer 30, distributed among the streamers 30, on the seismic source 40, on the survey vessel 30, at a remote land-based facility, etc. The system 320 may also be distributed on one or more of these entities, in accordance with other embodiments of the invention. In accordance with some embodiments of the invention, the system 320 may include a processor 350, such as one or more microprocessors and/or microcontrollers.

The processor 350 may be coupled to a communication interface 360 for purposes of receiving data indicative of seismic measurements including, pressure measurements and particle motion measurements. It is noted that the seismic data received by the communication interface 360 is further indicative of a split spread gather record, which was acquired directly by the seismic sensors of the seismic streamer spread. More specifically, in accordance with some embodiments of the invention, the record may contain pressure measurements only which were acquired by an over/under spread (depicted in FIG. 1); or, in other embodiments of the invention, the record may contain pressure and particle motion measurements that were acquired by one or more multi-component streamers. Thus, many variations are contemplated and are within the scope of the appended claims.

As a non-limiting example, the interface 360 may be a Universal Serial Bus (USB) serial bus interface, a network interface, a removable media (such as a flash card, CD-ROM, etc.) interface or a magnetic storage interface (IDE or SCSI interfaces, as examples). Thus, the interface 360 may take on numerous forms, depending on the particular embodiment of the invention.

In accordance with some embodiments of the invention, the interface 360 may be coupled to a memory 340 of the system 320 and may store, for example, various input and/or output data sets 348 involved with the techniques that are described herein. The memory 340 may store program instructions 344, which when executed by the processor 350, may cause the processor 350 to perform at least part and possibly all of one or more of the techniques that are described herein and display results obtained via the technique(s) on the display 374 of the system 320, in accordance with some embodiments of the invention. As depicted in FIG. 4, the system 320 may include a display interface 370 that couples the display device 374 to the system 320.

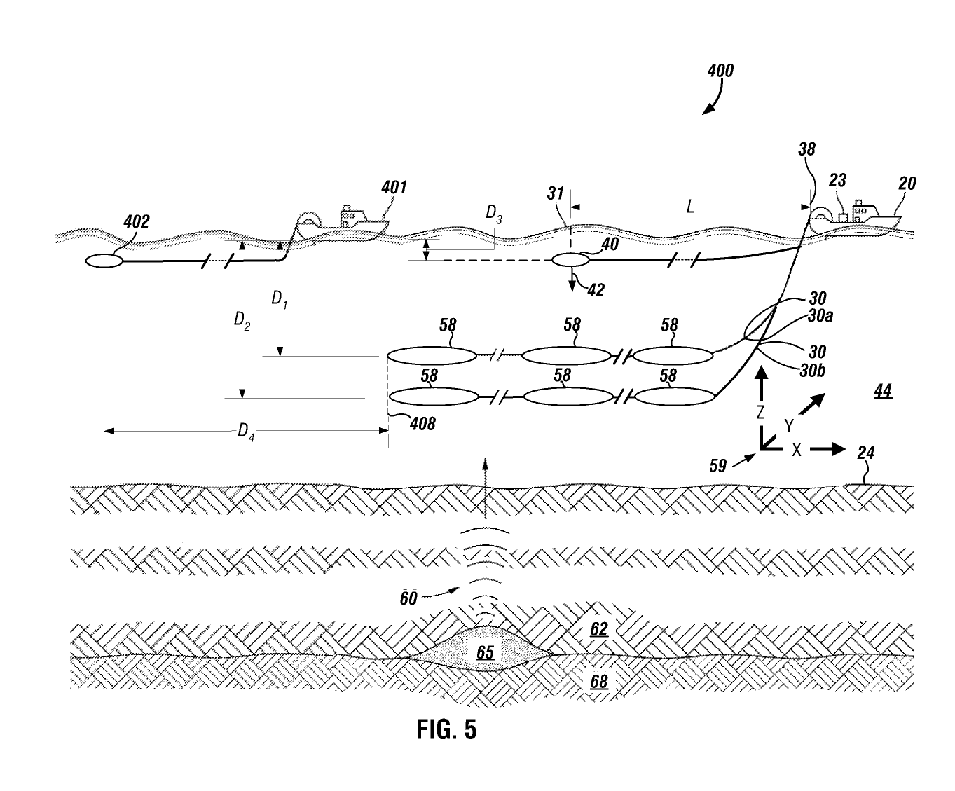

Other embodiments are contemplated and are within the scope of the appended claims. For example, referring to FIG. 5, in accordance with some embodiments of the invention, an alternative marine-based seismic data acquisition system 400 that is depicted in FIG. 5 may be used. Referring to FIG. 5, the system 400 is similar to the system 10 (FIG. 1), with the same reference numerals being used to denote similar components. However, unlike the system 10, the system 400 includes another seismic source 402 that is towed near a tail end 408 of the streamer spread. As depicted in FIG. 5 for purposes of example, the seismic source 402 may be towed by a given distance (called “D₄” in FIG. 5) behind the tail end 408. The seismic source 402 generates seismic signals 404 and may be towed by another vessel 401, although the source 402 may be towed by the vessel 20, in accordance with other embodiments of the invention. Thus, the seismic sensors 58 acquire seismic signals that are the result of the seismic signals that are generated by both seismic sources 40 and 402.

Other variations are contemplated. For example, in accordance with some embodiments of the invention, the distance D₄ may be negative, i.e., the source 402 may be towed in front of the tail end 408 but behind the source 40. Such a configuration permits both negative and positive offsets to be acquired from the energy that is generated by the source 402. As yet another variation, in accordance with other embodiments of the invention, the acquisition system may include the seismic source 402 and not include the seismic source 40. Thus, many variations are contemplated and are within the scope of the appended claims.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method comprising:
towing a spread of at least one streamer to acquire seismic data in response to energy produced by a seismic source; and
towing the seismic source at least 100 meters behind a front end of the spread to configure the spread to acquire a split spread gather record.

2. The method of claim 1, wherein the acts of towing the spread and towing the seismic source comprise:
using a vessel to tow the spread; and
towing the seismic source at least 100 meters behind the vessel.

3. The method of claim 1, wherein the act of towing the spread comprises:
towing the spread such that most of the spread has a depth of at least 50 meters.

4. The method of claim 1, wherein the act of towing the spread comprises towing an under/over spread or a spread of multi-component seismic sensors.

5. The method of claim 1, wherein the act of towing the seismic source comprises towing the seismic source at least one to two kilometers behind the front end of the spread.

6. The method of claim 1, wherein the act of towing the seismic source comprises towing the seismic source behind a tail end of the spread.

7. The method of claim 1, further comprising:
towing another seismic source closer to a tail end of the spread than to the front end of the spread.

8. The method of claim 7, wherein the act of towing said another seismic source comprises towing said another seismic source in front of the tail end of the spread.

9. The method of claim 7, wherein the act of towing said another seismic source comprises towing said another seismic source behind the tail end of the spread.

10. The method of claim 7, wherein the acts of towing the seismic source at least 100 meters behind the front end and towing said another seismic source comprise towing the seismic sources using different vessels.

11. A method comprising:
receiving a split spread gather record acquired by seismic sensors while in tow; and
processing the split spread seismic record to remove free surface effects indicated by the record.

12. The method of claim 11, wherein the act of receiving the split spread gather record comprises:
receiving measurements acquired by seismic sensors located on a side of a seismic source between a vessel that towed the seismic sensors and the seismic source; and
receiving measurements acquired by seismic sensors located on the opposite side of the seismic source.

13. The method of claim 11, wherein the processing comprises processing the split spread gather record to remove source noise.

14. The method of claim 13, wherein the processing further comprises processing the split spread gather record to perform interpolation and deghosting.

15. The method of claim 11, wherein the processing comprises processing the split spread gather record to remove multiples.

16. A system comprising:
a seismic source;
a spread of at least one streamer to acquire seismic data in response to energy produced by a seismic source; and
a vessel to tow the seismic source at least 100 meters behind a front end of the spread such that the spread acquires a split spread gather record.

17. The system of claim 16, wherein the seismic source is adapted to be towed at least 100 meters behind the vessel.

18. The system of claim 16, wherein the spread is configured to be towed such that most of the spread has a depth greater than 50 meters.

19. The system of claim 16, wherein the spread comprises streamers arranged in an under/over arrangement.

20. The system of claim 16, wherein the at least one streamer comprises pressure and particle motion sensors.

21. The system of claim 16, wherein the seismic source is adapted to be towed at least one to two kilometers behind the vessel.

22. The system of claim 16, wherein the vessel is adapted to tow the seismic source behind a tail end of the spread.

23. The system of claim 16, further comprising:
another seismic source to be towed closer to a tail end of the spread than to the front end of the spread.

24. The system of claim 23, wherein said another seismic source is adapted to be towed in front of the tail end of the spread.

25. The system of claim 23, wherein said another seismic source is updated to be towed behind the tail end of the spread.

26. The system of claim 23, further comprising:
another vessel to tow said another seismic source.

27. A system comprising:
an interface to receive a split spread gather record acquired by seismic sensors while in tow; and
a processor to process the split spread gather record to remove free surface effects indicated by the record.

28. The system of claim 27, wherein the processor is adapted to:
process data indicative of measurements acquired by seismic sensors located on a side of a seismic source between a vessel that towed the seismic sensors and the seismic source; and
process data indicative of measurements acquired by seismic sensors located on the opposite side of the seismic source.

29. The system of claim 27, wherein the processor processes the split spread gather record to remove source noise.

30. The system of claim 27, wherein the processor processes the split spread gather record to remove multiples.
